(19) United States
(12) Patent Application Publication
(10) Pub. No.: US 2011/0083898 A1
(43) Pub. Date: Apr. 14, 2011

(54) TANGLE RESISTANT FLEXIBLE ELONGATED DEVICE

(76) Inventor: John F. Miller, III, Indianola, MS (US)

(21) Appl. No.: 12/788,555

(22) Filed: May 27, 2010

Related U.S. Application Data
(60) Provisional application No. 61/250,215, filed on Oct. 9, 2009.

(51) Int. Cl. H02G 3/00; F16L 55/00; D02G 3/22

(52) U.S. Cl. 174/70 R; 138/103; 57/200; 428/371

(57) ABSTRACT

A device is provided that includes a flexible elongated member and a spiral member. The spiral member is engaged with at least a portion of the flexible elongated member. The spiral member asserts a biasing force on the flexible elongated member to prevent the flexible elongated member from becoming tangled.

### CROSS REFERENCE TO RELATED APPLICATION

This application claims priority from U.S. Provisional Application Ser. No. 61/250,215 filed Oct. 9, 2009, the disclosure of which is incorporated by reference.

### BACKGROUND

Flexible elongated members such as extension cords, coax, cables, wires, ropes etc. are subject to become tangled which can lead to wasted time and frustration on the part of the user. For the reasons stated above and for other reasons stated below which will become apparent to those skilled in the art upon reading and understanding the present specification, there is a need in the art for a relatively tangle resistant flexible elongated device.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a device is provided that includes a flexible elongated member; and a spiral member. The spiral member is engaged with at least a portion of the flexible elongated member. The spiral member asserts a biasing force on the flexible elongated member to prevent the flexible elongated member from becoming tangled.

### BRIEF DESCRIPTION OF THE DRAWINGS

The present invention can be more easily understood and further advantages and uses thereof be more readily apparent, when considered in view of the detailed description and the following figures in which:

FIG. 1 is a top perspective view of a flexible elongated member with a spiral member of one embodiment of the present invention;

FIG. 2 is a top perspective view of the flexible elongated member with the spiral member of FIG. 1 in a rolled up configuration;

FIG. 3 is a top perspective view of a flexible elongated member having a portion with a coating 202 of another embodiment of the present invention;

FIG. 4A is a close up view of a spiral member on an outer surface of a flexible elongated member of one embodiment of the present invention;

FIG. 4B is a close up view of a spiral member encased in a covering of a flexible elongated member of another embodiment of the present invention;

FIG. 4C is a close up view of a spiral member on an inner surface of a flexible member of yet another embodiment of the present invention; and

FIG. 5 is a close up view of a spiral member coupled to a ground of a flexible member of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

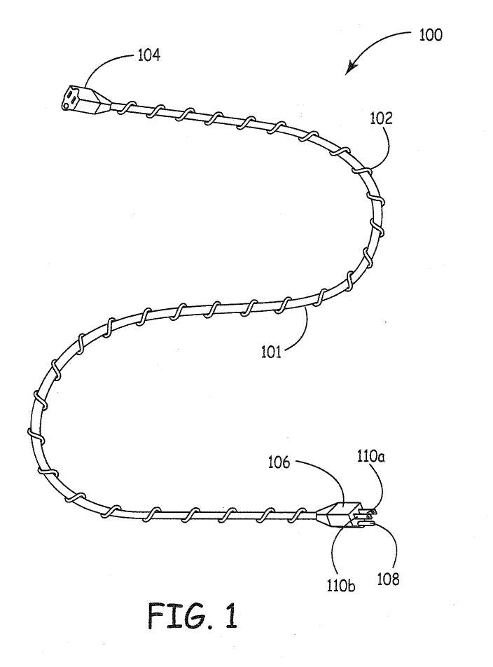

Embodiments of the present invention provide a flexible elongated member that includes a spiral member that exerts a biasing force on the elongated member to help prevent the elongated member from becoming tangled. Referring to FIG. 1, a top view of a tangle resistant flexible elongated member 100 of an embodiment is illustrated. The tangle resistant flexible elongated member 100 including a spiral member 102 and a flexible elongated member 10. As illustrated, the spiral member 102 encases the elongated member 101. The spiral member 102 is made from a material that provides a biasing force on the elongated member 101 that acts to help prevent the elongated member 101 from becoming entangled with itself. FIG. 1 further illustrates that the tangle resistant flexible elongated member 100 in this example embodiment is an extension cord.

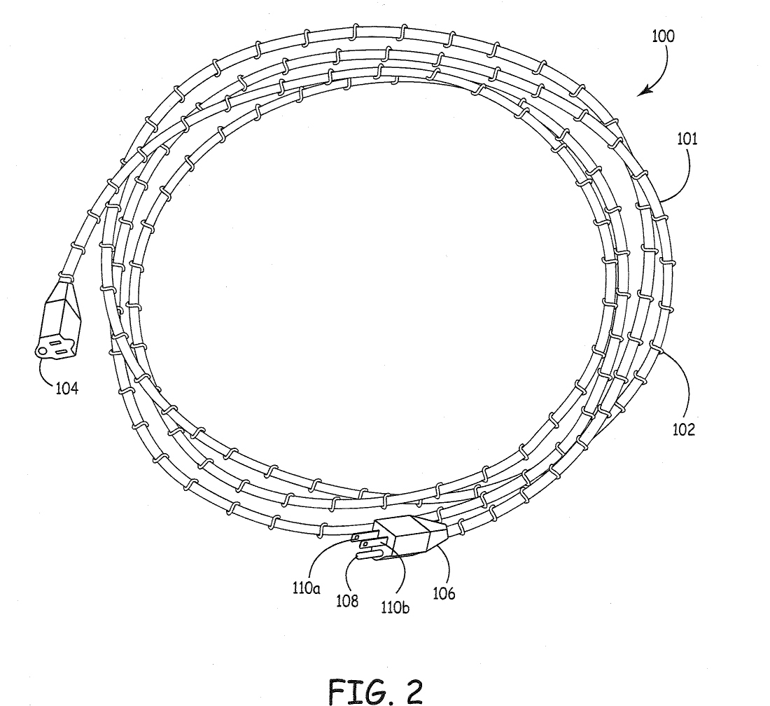

As stated above, the spiral member 102 is made from material that exerts a biasing force on the elongated member 101. Any type of material that can provide the biasing force can be used. Example materials include, but are not limited to, metals, plastics, composite materials, vinyl, fiberglass, rope etc. Although, the spiral member 102 is illustrated as having a spiral shape any type of biasing member can be used that provides a biasing force on the elongated member to prevent it from becoming tangled. The flexible elongated member 101 can be any type of flexible elongated member 101 that is prone to get tangled. Example elongated members 101, include but are not limited to, cords, extension cords, coax, cable, wire, rope, hoses, etc. In FIG. 1, the elongated member 100 is illustrated as an extension cord having a first female end 104 and a second male end 106. The male end 106 includes power contacts 110a and 110b and ground contact 108. As further stated above, the spiral member 102 provides a biasing force on the flexible elongated member 101 to prevent the flexible elongated member 101 from becoming tangled. When the tangle resistant flexible elongated member 100 is prepared for storage (wound up), the spiral member 102 helps provide a tangle resistant storage configuration of the elongated member 101 as illustrated in FIG. 2.

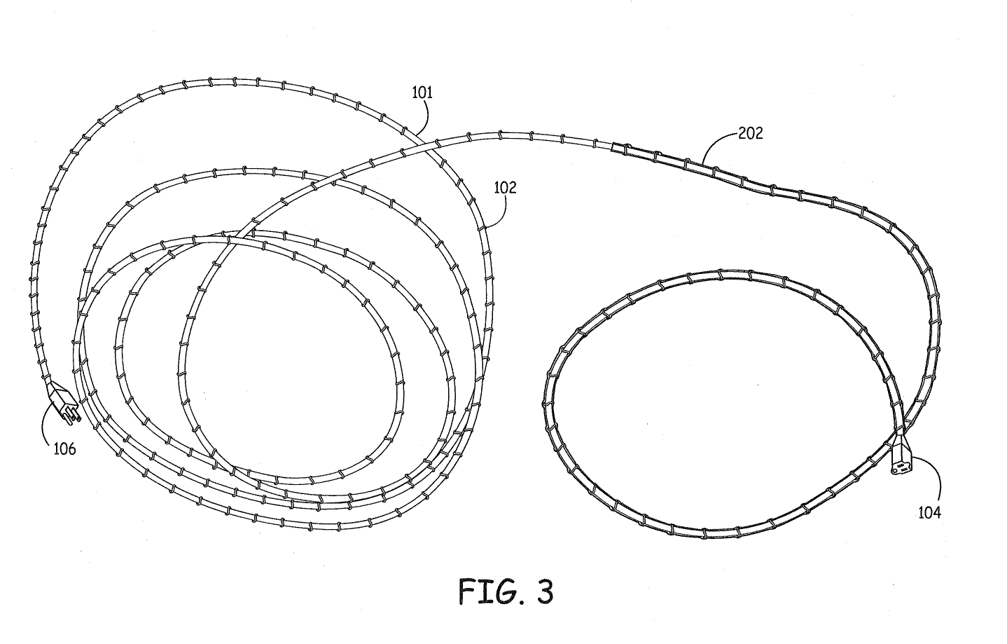

Referring to FIG. 3, in one embodiment a coating 202 is used to cover the spiral member 102 and the elongated member 101. In particular, FIG. 3 illustrates a partial coating 202 of the elongated member 101. The coating 202 helps prevent the spiral member 102 from getting caught on objects as the elongated member 100 is moved. The coating 202 is made from a material that is flexible so the elongated member 101 can be rolled up when not in use and so the coating 202 does not fall off or fall apart. Any type of flexible coating material can be used that accomplishes this task. Example coatings 202 include, but are not limited to, plastic, rubber, vinyl, etc. A coating 202 can be used on an embodiment where the spiral member (of the bias member) is positioned around an outer surface of the elongated member 101.

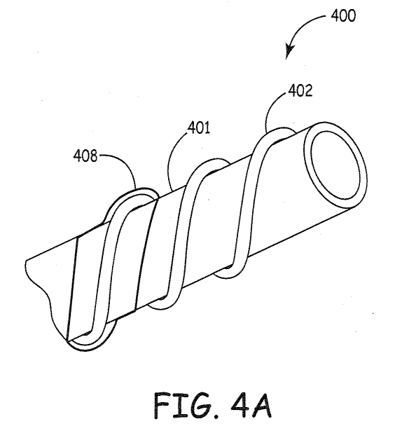

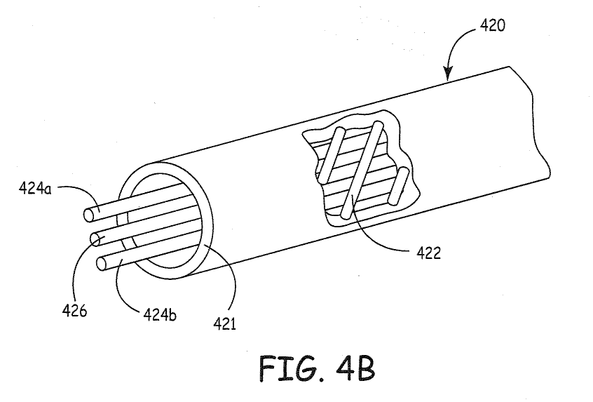

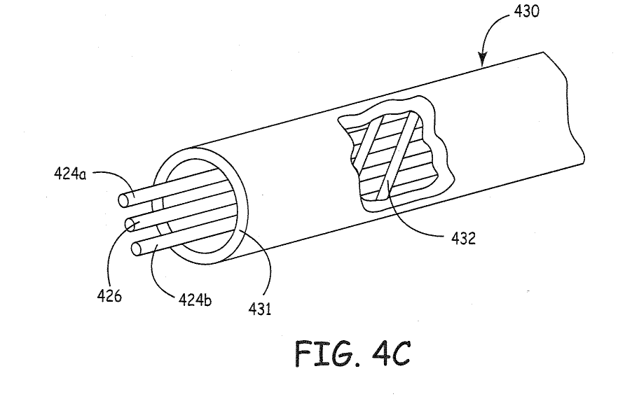

FIG. 4A illustrates a close up partial view of a spiral member 402 and an elongated member 401 of a tangle resistant flexible elongated member 400 of one embodiment. In this embodiment, the spiral member 402 is positioned around an outer surface of the elongated member 401. This embodiment may also include a coating 408 similar to coating 202 discussed above. The tangle resistant flexible elongated member 400 can be any type of elongated flexible device as stated above, including, but not limited to, an electric extension cord, a coax, a cable, a wire, a rope, and a hose such as a water hose and a gas hose and the like. FIG. 4B illustrates a close up partial view of another tangle resistant flexible elongated member 420 of one embodiment. In this embodiment, the spiral member 422 is received in the elongated member (which includes a cover 421). That is, in this embodiment the spiral member 422 is formed into the elongated member's cover 421. This example embodiment is an extension cord 420 including a pair of power wires 424a and 424b and a ground wire 426 that are received in the cover 421. In one embodiment, the power wires 424a and 424b include a neutral wire 424a and a hotwire 424b. FIG. 4C illustrates yet another embodiment of a tangle resistant flexible elongated member 430. In this embodiment, the spiral member 432 is positioned inside of an inner surface of a cover 431 of the elongated member 430. Here again, the tangle resistant flexible elongated member 430 is an electric extension cord with a pair of power wires 424a and 424b and a ground wire 426 received in the cover 431.

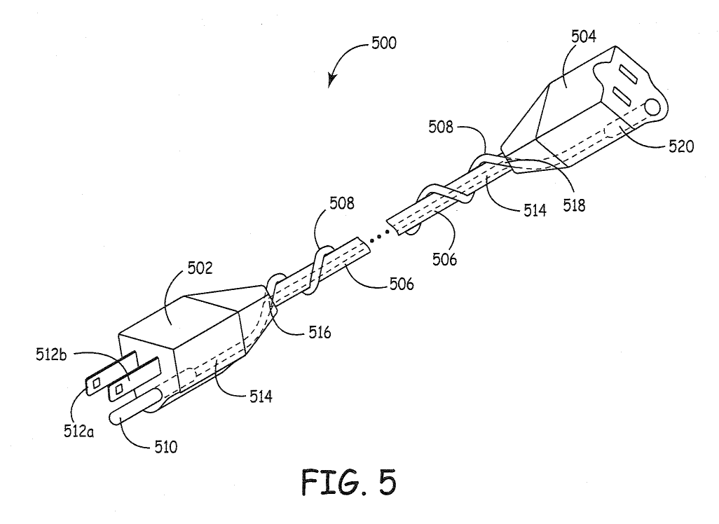

FIG. 5 illustrates an embodiment of a tangle resistant flexible extension cord 500. This embodiment, illustrates the spiral member 508 (biasing member) being positioned around an outer surface of the elongated member 506 (cord). Although, the spiral member 508 is positioned around the outer surface of the elongated member 506 in this example embodiment, in other embodiments it is positioned within a cover of the elongated member or inside the inner surface of the cover of the elongated member. The extension cord 500 is further illustrated as including a male end 502 having power connectors 512a and 512b and ground 510 and a female end 504 having female connectors (including a female ground connector 520) that are electrically coupled to the respective male end connectors 512a, 512b and 510. In this embodiment, the spiral member 508 is made from a conductive material. The spiral member 508 in this embodiment is further coupled to the coupling (i.e. to the ground wire 514 of the extension cord 500) between the male ground connector 510 and the female ground connector 520. In particular, in this embodiment a first end the spiral member 508 is coupled to the ground wire 514 about a first connection point 516 in the male end 502 of the extension cord 500 and a second end of the spiral member 508 is coupled to the ground wire 514 about a second connection point 518 in the female end 504 of the extension cord 500.

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. Therefore, it is manifestly intended that this invention be limited only by the claims and the equivalents thereof.

1. A tangle resistant flexible elongated device, the device comprising:
a flexible elongated member; and
a spiral member engaged with at least a portion of the flexible elongated member, the spiral member asserting a biasing force on the flexible elongated member to prevent the flexible elongated member from becoming tangled.

2. The device of claim 1, wherein the flexible elongated member is one from a group consisting of an extension cord, a coax, a cable, a wire, a rope, and a hose.

3. The device of claim 1, wherein the flexible elongated member is a grounded extension cord, the spiral member further coupled to a ground wire of the grounded extension cord.

4. The device of claim 1, wherein the spiral member is made from a material selected from a group comprising metal, plastic, vinyl, composite material, fiberglass and rope.

5. The device of claim 1, further comprising:
a coating covering the spiral member to prevent the spiral member from getting caught on objects.

6. The device of claim 5, wherein the coating is one from a group consisting of a rubber coating, a plastic coating and a vinyl coating.

7. The device of claim 1, wherein the spiral member is positioned around an outside surface of the flexible elongated member.

8. The device of claim 1, wherein the spiral member is received within the flexible elongated member.

9. The device of claim 1, wherein the spiral member is positioned proximate an inner surface of the flexible elongated member.

10. A tangle resistant elongated device, the device comprising;
a flexible elongated member; and
a biasing member configured and arranged to provide a biasing force on at least a portion of the flexible elongated member to prevent the elongated member from becoming tangled.

11. The device of claim 10, wherein the flexible elongated member is one from a group consisting of an extension cord, a coax, a cable, a wire, a rope, and a hose.

12. The device of claim 10, wherein the biasing member is made from a material selected from a group comprising metal, plastic, vinyl, composite material, fiberglass and rope.

13. The device of claim 10, wherein the flexible elongated member is an extension cord.

14. The device of claim 13, wherein the extension cord including a ground wire, further wherein the biasing member is made from a conductive material, the biasing member coupled to the ground wire.

15. The device of claim 10, wherein the biasing member is a spiral member.

16. An electric extension cord, the electric extension cord comprising:
a cover;
a pair of power wires received in the cover; and
a biasing member in contact with the cover configured and arranged to assert a biasing force on the cover to prevent the cord from becoming tangled.

17. The electric extension cord of claim 16, wherein the biasing member is positioned around an outer surface of the cover.

18. The electric extension cord of claim 17, further comprising:
a coating covering the biasing member.

19. The electric extension cord of claim 16, further comprising:
a ground wire; and
the biasing member being conductive, the biasing member being electrically coupled to the ground wire.

20. The electric extension cord of claim 16, wherein the biasing member is spiral in shape.
